(19) United States
(12) Patent Application Publication
(10) Pub. No.: US 2003/0084229 A1
(43) Pub. Date: May 1, 2003

(54) Methods and apparatus for modifying programs stored in read only memory

(76) Inventors: Tat N. Ho, New Milford, CT (US); Terry L. Engel, Bristol, CT (US); Qin Wang, Bristol, CT (US)

Correspondence Address: David P. Gordon, 65 Woods End Road, Stamford, CT, 06905, US

(21) Appl. No.: 10/047,509

(22) Filed: Oct. 23, 2001

(51) Int. Cl. G06F 13/00

(52) U.S. Cl. 711/102

(57) ABSTRACT

The apparatus of the invention includes an embedded device having program code stored in ROM and an on-board or external RAM for storing modified code segments. The methods of the invention include structuring the ROM-based firmware so that an external RAM-based function is called prior to each potentially modifiable code segment. Prior to modifying the firmware, a dummy function is stored in RAM so that every call to RAM is simply returned to ROM. When a segment of code is to be modified, a replacement is stored in RAM and indexed by the return address of the function call. The system of the present invention is efficient as it uses very little RAM. It does not require ROM-based decision making; and it is not limited to a particular programming language. The system of the invention is most suitable for use in a computer peripheral which communicates with a higher level controller, e.g. a personal computer, from which replacement code can be downloaded.

### BACKGROUND OF THE INVENTION

1. Field of the Invention

The invention relates to embedded systems. More particularly, the invention relates to methods and apparatus for modifying embedded system programs stored in read only memory (ROM).

2. State of the Art

Digital computing systems are typically known to include hardware and software. Software is typically stored on a writable medium such as a magnetic disk. As most computer users know, software often contains errors or mistakes which prevent it from functioning properly. Software vendors often publish updates or “patches” to correct errors in software. An update is typically a new complete version of the original software which is intended to replace the entire original program. The original software is erased from the writable medium and the replacement software is written to the writable medium in place of the original. A patch is a program which is run to modify the original software. The patch program finds the portion(s) of the software which need to be replaced and overwrites them with replacement code.

Today, digital computing systems are ubiquitous and often unseen. These systems are designed to perform specialized functions such as controlling the operation of an appliance, a motor vehicle, or a computer peripheral device such as a modem or a printer. Such computing systems are usually referred to as “embedded systems”. They include a microprocessor and software which is typically stored on a read only memory (ROM). ROM is advantageous because it is non-volatile, small, inexpensive, and energy efficient. Program code stored on ROM is usually called “firmware” rather than software because once it is stored on ROM, the code cannot be modified. The code takes on the quality of hardware in the sense that in order to change it, the physical ROM device must be replaced. Indeed, many embedded systems have “socketed” ROM so that the ROM can be easily unplugged and replaced with a new ROM if the program needs to be changed. However, that is not always practical or convenient.

One known method for alteration of firmware programs in ROM-based systems is disclosed in U.S. Pat. No. 4,607,332, issued on Aug. 19, 1986 to Goldberg. The method allows for dynamic alteration of ROM programs with the aid of random access memory (RAM) and through the use of the standard linkages associated with subroutine calls in the system processor. When each ROM-based routine is written, one program statement is a call to a ROM-located processing routine which searches a RAM-located data structure. If there exists a correspondence between information passed on the call to the processing routine and certain elements of the data structure, a RAM-based program is substituted for the ROM-based program. After adjusting the processor to the states just after the call to the ROM-based program, the processing routine effects a transfer to the replacement routine in RAM. The location of this replacement routine is also found in the data structure. The main disadvantage of the method proposed by Goldberg is that it is inefficient. It uses up too much space in ROM and RAM. It also requires an external compiler/interpreter. Since the processing function is ROM-based, it is limited in scope and potential to be modified. The ROM-based function also presents excessive processing overhead since it must perform a search for possible replacement code even when no replacement code exists

Another system for altering ROM-based firmware is disclosed in U.S. Pat. No. 5,740,351, issued on Apr. 14, 1998 to Kasten. The system relies on an “extensible interpreter”, i.e. a modified FORTH kernel and a plurality of customizable call outs (CCOs). CCOs are present in the ROM-based program. When a CCO is encountered during execution of the program, the modified FORTH kernel takes control and looks for the called function or parameter. If it is found (in RAM or in ROM), it is executed or fetched and the result is returned by the modified FORTH kernel to the next instruction in the ROM program. The system is primarily intended for interactive use with a dumb terminal during “debugging” of the ROM-based program. CCOs in RAM must be defined using the modified FORTH kernel. The main advantage of Kasten over Goldberg is that Kasten does not require an external compiler/interpreter. Disadvantages of Kasten are that it is limited to modifications made using the FORTH programming language and it is inefficient, requiring that a substantial part of ROM be devoted to the modified FORTH kernel.

Still another system for altering software in embedded systems is disclosed in U.S. Pat. No. 5,901,225, issued on May 4, 1999 to Ireton et al. The system includes an embedded system device coupled to an external memory. The device includes a non-alterable memory, including firmware, coupled to a processor. The device further includes a relatively small amount of patch RAM within the device also coupled to the processor. Patches are loaded from the external memory into the patch RAM. The device further includes a means for determining if one or more patches are to be applied. If the device detects a patch to be applied, the system loads the patch from the external memory into the patch RAM. The device also includes a breakpoint register. When the value of the program counter of the processor equals the value in the breakpoint register, a patch insertion occurs, i.e., the processor deviates from executing firmware to executing patch instructions. The system described by Ireton et al. is quite complex.

### SUMMARY OF THE INVENTION

It is therefore an object of the invention to provide methods and apparatus for modifying firmware code stored in a read only memory.

It is also an object of the invention to provide methods and apparatus for modifying firmware code stored in a read only memory which make efficient use of RAM.

It is another object of the invention to provide methods and apparatus for modifying firmware code stored in a read only memory which are relatively simple in architecture.

It is also an object of the invention to provide methods and apparatus for modifying firmware code stored in a read only memory which do not require any decision making elements in ROM to support future code modifications.

It is another object of the invention to provide methods and apparatus for modifying firmware code stored in a read only memory which do not require any processor specific or processor dependent elements.

It is still another object of the invention to provide methods and apparatus for modifying firmware code stored in a read only memory which are applicable to any programming language.

It is also an object of the invention to provide methods and apparatus for modifying firmware code stored in a read only memory which do not limit the scope of future code modifications.

It is another object of the invention to provide methods and apparatus for modifying firmware code stored in a read only memory which incur minimum processing overhead.

It is still another object of the invention to provide methods and apparatus for modifying firmware code stored in a read only memory which minimize the size of ROM code segments needed to be replaced to fix an error.

In accord with these objects which will be discussed in detail below, the apparatus of the invention includes an embedded device having program code stored in ROM and an on-board or external RAM for storing modified code segments. The methods of the invention include structuring the ROM-based firmware so that a RAM-based function is called prior to each potentially modifiable code segment. Prior to modifying the firmware, a dummy function is stored in RAM so that every call to RAM is simply returned to ROM. When a segment of code is to be modified, a replacement is stored in RAM and indexed by the return address of the function call. The system of the present invention is efficient as it uses very little RAM. It does not require any ROM-based decision making elements; and it is not limited to a particular programming language or processor. The system of the invention is most suitable for use in a computer peripheral which communicates with a higher level controller, e.g. a personal computer, from which replacement code can be downloaded. Alternatively, replacement code in RAM can be loaded by a small bootstrap program (i.e. a run-time system initialization program) stored in replaceable external ROM.

Additional objects and advantages of the invention will become apparent to those skilled in the art upon reference to the detailed description taken in conjunction with the provided figures.

### BRIEF DESCRIPTION OF THE DRAWINGS

FIG. 1 is a simplified block diagram of an embedded system according to the invention;

FIG. 2 is a schematic illustration of the organization of ROM-based code according to the invention;

FIG. 3 is a schematic illustration of the dummy function in RAM according to the invention;

FIG. 4 is a schematic illustration of the replacement code in RAM indexed to return address; and

FIG. 5 is a simplified flowchart of the operation of the invention.

### DETAILED DESCRIPTION OF THE PREFERRED EMBODIMENTS

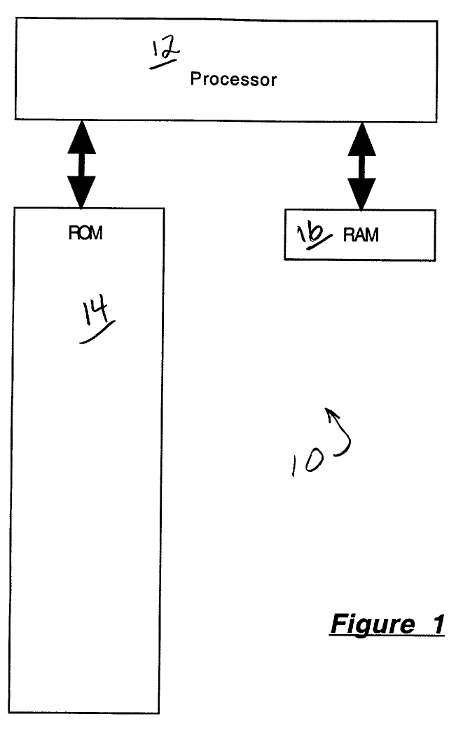

Referring now to FIG. 1, an embedded system 10 according to the invention includes a processor 12 which is coupled to a firmware ROM 14 and a RAM 16. As illustrated in FIG. 1, the RAM 16 is ideally much smaller than the ROM 14, for example approximately one one hundredth the size of the ROM.

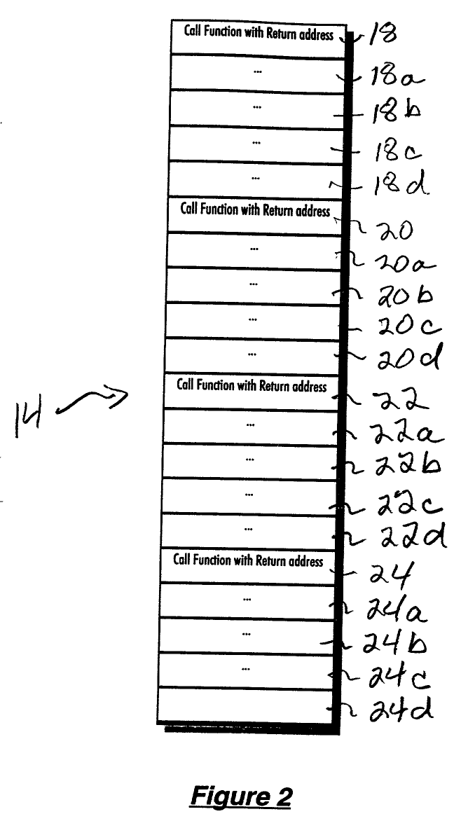

Turning now to FIG. 2, according to the invention, the firmware stored in the ROM 14 is divided into code segments, e.g. 18a-18d, 20a-20d, 22a-22d, and 24a-24d. Prior to the start of each code segment, a call function with a (calling and) return address is placed, e.g. at 18, 20, 22, and 24. The locations of the call functions are preferably organized for the most efficient use of RAM. It might seem practical to locate each call function at each logical break in the code, e.g. at the start of each new routine. However, in the case of very long routines, it can be more efficient to place call functions equally spaced throughout the routine. This will be better understood after considering the code listings below. Essentially, whenever replacement code is used, all of the code from the call function until the corrected code is reached is replaced. Thus if there are one thousand lines of code between call functions and only the six hundredth line of that code needs to be changed, six hundred lines will be replaced nonetheless. If the call functions were spaced every one hundred lines throughout the thousand line routine, no more than one hundred lines would need to be replaced. Thus, a balance must be struck between the number of call functions placed throughout the ROM-based code and the amount of RAM needed to make code replacements.

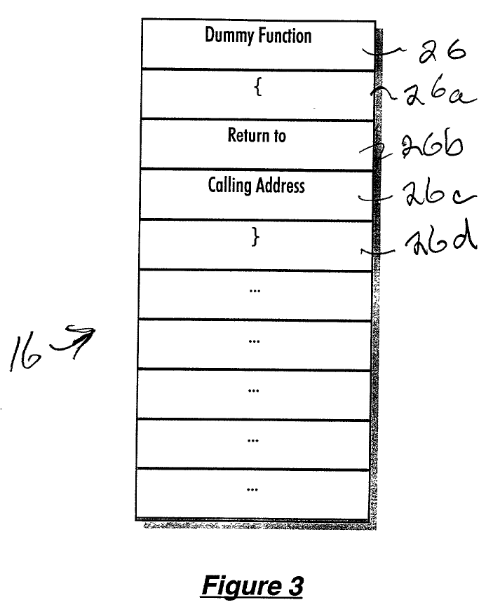

FIG. 3 illustrates the structure of RAM 16 when none of the code segments in ROM is to be replaced. A dummy function 26, including instruction lines 26a-26d resides in RAM 16. Whenever a call function (18, 20, 22, 24 in FIG. 2) is executed, the dummy function 26 responds by returning program execution to the return address (which is usually the next line after the calling function).

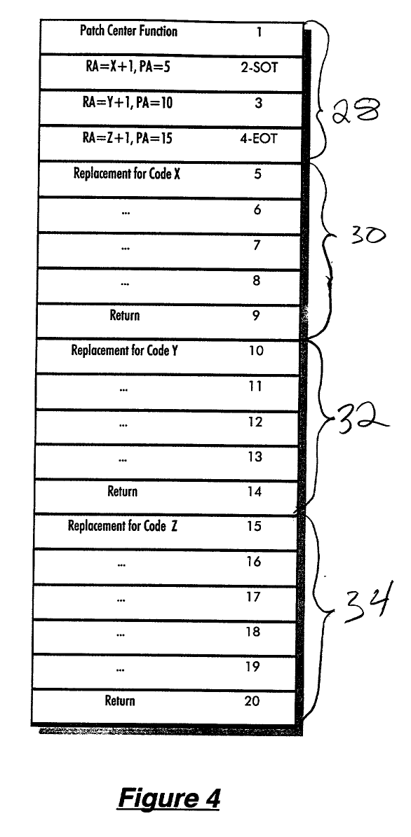

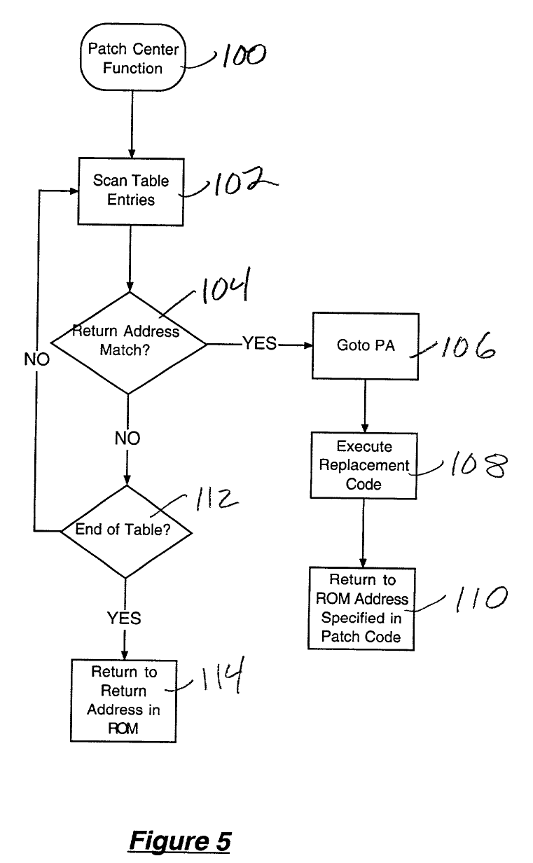

FIG. 4 illustrates the structure of RAM 16 when some of the code segments in ROM are to be replaced. In this case, the Return in the Dummy Function is replaced with a branch to the corresponding Patch Center Function. According to the presently preferred embodiment, a lookup table 28, including a “patch center function” (line 1 of the RAM table) provides the functionality necessary to determine whether a code segment has a replacement in RAM. Operation of the patch center function is described in more detail below with reference to FIG. 5 and Code Listing 2. The lookup table is illustrated schematically at lines 2-4 of the RAM table, line 2 being the start of table (SOT) and line 4 being the end of table (EOT). Each entry in the lookup table refers to a return address (RA) and a patch address (PA). For example, the first entry refers to a return address of X+1 and a patch address of 5. This signifies that the code being replaced is a replacement (shown at 30 in FIG. 4) for code segment X; the replacement code begins at line 5 in the RAM table and upon execution of the replacement code, execution continues at an address specified in the replacement code, typically the next segment after X. It is possible to replace only a portion of a code segment and return to a line within the original code segment to continue execution. As will be seen below in Code Listing 2, it is necessary to replace a contiguous set of code lines from the call function forward. Similar entries are indicated for code segment Y and Z replacements which are illustrated at 32 and 34 in FIG. 4.

Referring now to FIG. 5, when the patch center function is called at 100, the lookup table entries are scanned at 102. If a return address match is found at 104, program execution is directed to the patch address at 106. The replacement code is executed at 108, and program execution is returned to a ROM address specified in the patch code at 110. So long as the end of the table has not been reached as determined at 112, the patch center function looks for a table entry for replacement code. When it is determined that the end of the table has been reached, program execution returns to the return address in ROM at 114. As mentioned above, if there is no replacement code in RAM, program execution returns to the return address specified by the call function which also acts as an index to the lookup table. If replacement code is executed, the return address is specified by the replacement code.

The operation of the invention will be better understood with reference to the following Code Listing 1 and Code Listing 2 which illustrate the structure of the code in ROM and RAM respectively.

Code Listing 1 (ROM Segment)

*******************************
* Code Listing 1 (ROM Segment)
*******************************
Code_in Rom:

| | |
|---|---|
| Patch_Call1() | ; Function call |
| . | |
| . | |
| . | |
| Patch_Call1() | |
| . | |
| . | |
| . | |
| Patch_Call2() | |

| | |
|---|---|
| ROM_Return_Addr2: | ; Return Address (RA) |

| | |
|---|---|
| I = I + 10 | ; Segment code starts |
| K + K − 55 | ; Need moficiation ! |

ROM_Address2:

| | |
|---|---|
| M = M + 88 | |
| . | |
| . | ; segment code ends |
| Patch_Call2() | |
| J '2 J − 15 | |
| . | |
| . | |
| Patch_Call2() | |
| . | |
| . | |
| . | |
| Patch_Call3() | |
| . | |
| . | |
| . | |
| Patch_Call3() | |

Referring to Code Listing 1, a code segment is shown with seven patch calls at lines 7, 11, 15, 23, 27, 31, and 35. Most of the code is not shown but is represented by dots, i.e. at lines 8-10, 12-14, 21, 22, 25, 26, 28-30, and 32-34. The code which will be modified follows patch call2( ) at line 15.

Code Listing 2 (RAM Segment)

*******************************
* Code Listing 2 (RAM Segment)
*******************************

| Code_in_RAM: | | |
|---|---|---|
| Patch_Call1 | | ; Dummy function |
| | Return | ; Return to ROM Code |
| Patch_Call2: | | ; Dummy Function |
| | Go to Patch_Center 2 | ; Replace Return here ! |
| Patch_Call3: | | ; Dummy Function |
| | Return | ; Return to ROM Code |
| | . | |
| | . | |
| | . | |
| Patch_Center2: | | ; Patch Center Function |
| | Save_Context() | ; Save necessary registers |
| | Address_Match = Patch_Address_Table_Search() | ; Lookup table searching |
| | if (Address_Match == YES) | |

| | |
|---|---|
| Go to Patch_Code 2 | ; Have replacement code |

else

| | |
|---|---|
| Restore_Context() | ; Restore the registers |
| Return | ; Return to ROM code |

| Patch_Center2_Lookup_SOT: | | ; Start of Lookup Table |
|---|---|---|
| | ROM_Return_Addr2 | ; Return Address (RA) |
| | Patch_Code2 | ; Patch Address (PA) |
| | . | |
| | . | |
| | . | |
| Patch_Center_Lookup_EOT: | | ; End of Lookup Table |
| Patch_Code2: | | ; Patch Address (PA) |
| | I = I + 10 | ; Replacement code |
| | K = K − 99 | ; Replace K = K − 55 in ROM |
| | Restore_Context() | ; Restore the registers |
| | Return to ROM_Address2 | |

Turning now to Code Listing 2, lines 6-13 represent the dummy functions. As shown, patch calls 1 and 3 are dummy functions which return the program to ROM. Patch call 2 directs the program to patch center 2 which begins at line 18. Patch center 2 saves the context and checks the address match. The address match lookup table is illustrated at lines 31-37. If the address matches, the program is directed to patch code 2 which starts at line 39. If the address does not match, context is restored and the program is returned to ROM. As shown at lines 39-43, patch code 2 is designed to replace two lines of code in code listing 1, i.e. replace lines 17 and 18 of code listing 1 with lines 34 and 35 of code listing 2. After executing lines 40 and 41 of code listing 2, context is restored at line 42 and the program is returned to ROM at 43. The return address is indicated in code listings 1 and 2 as ROM_Address2. The actual return address is derived from knowledge of the code in ROM. It should be noted that line 40 of code listing 2 is identical to line 17 of code listing 1. Nevertheless, it is replaced because, as mentioned above, the function calls according to the invention allow and require replacement of all code from the function call through the corrected code.

There have been described and illustrated herein methods and apparatus for modifying program code stored in ROM. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as so claimed.

1. A method of modifying program code stored in read only memory (ROM), comprising:
a) preceding each potentially modifiable code segment in ROM with a call to a lookup function which is logically external to the ROM;
b) storing the lookup function in a random access memory (RAM);
c) storing replacement code segments in the RAM with addresses;
d) providing the lookup function with an address table whereby the lookup function determines whether or not each potentially modifiable code segment in ROM has a replacement code segment in RAM; and
e) executing the replacement code segment in RAM in place of the potentially modifiable code segment in ROM whenever the lookup function determines that a potentially modifiable code segment in ROM has a replacement code segment in RAM.

2. A method according to claim 1, wherein:
each call to the lookup function includes a return address corresponding to the code segment it precedes.

3. A method according to claim 2, further comprising:
f) returning to the return address when the lookup function determines that there is no replacement code segment in RAM corresponding to the return address.

4. A method according to claim 2, wherein:
the return addresses are used to index the address table.

5. A method according to claim 1, wherein:
each replacement code segment includes a ROM address to which program execution will return after executing the replacement code segment.

6. A method according to claim 1, wherein:
said method operates independent of programming language.

7. A method according to claim 1, wherein:
the ROM is part of a computer peripheral, and
the RAM is loaded by the computer.

8. A method according to claim 1, wherein:
the RAM is loaded by a bootstrap program.

9. A method according to claim 7, wherein:
the computer peripheral is a modem.

10. An embedded system, comprising:
a) a processor;
b) a read only memory (ROM) coupled to said processor and containing program code for execution by said processor; and
c) a random access memory (RAM) coupled to said processor and containing at least one replacement code segment for replacing a segment of said program code in ROM and a lookup function, wherein
each potentially modifiable code segment in ROM is preceded with a call to said lookup function,
said at least one replacement code segment has an address,
said lookup function has an address table whereby the lookup function determines whether or not each potentially modifiable code segment in ROM has a replacement code segment in RAM, and
said processor executes the replacement code segment in RAM in place of the potentially modifiable code segment in ROM whenever the lookup function determines that a potentially modifiable code segment in ROM has a replacement code segment in RAM.

11. An embedded system according to claim 10, wherein:
each call to said lookup function includes a return address corresponding to the code segment it precedes.

12. An embedded system according to claim 11, wherein:
said processor returns to the return address when the lookup function determines that there is no replacement code segment in RAM corresponding to the return address.

13. An embedded system according to claim 11, wherein:
the return addresses are used to index the address table.

14. An embedded system according to claim 10, wherein:
each replacement code segment includes a ROM address to which program execution will return after executing the replacement code segment.

15. An embedded system according to claim 10, wherein:
said embedded system is part of a modem.

16. A method of modifying program code stored in read only memory (ROM), comprising:
a) preceding each potentially modifiable code segment in ROM with a call to a function which is logically external to the ROM;
b) storing the function(s) in a random access memory (RAM); and
c) executing the function in RAM when called by the calls in ROM.

17. A method according to claim 16, wherein:
said functions are chosen from the group consisting of a dummy function which returns execution to ROM and a fragment of replacement code which is executed and returns to ROM at an address subsequent to the address of the call which called the function.

18. A method according to claim 16, wherein:
the calls to functions are evenly spaced throughout the code in ROM.

19. A method according to claim 16, wherein:
said step of storing functions in RAM is executed at run-time.
